(19) United States
(12) Patent Application Publication
(10) Pub. No.: US 2026/0253057 A1
(43) Pub. Date: Aug. 27, 2026

(54) COIN TRANSFER BETWEEN CRYPTO WALLET AND POOL WALLET

(71) Applicant: SENDTECH INNOVATIONS LTD., Larnaka (CY)

(72) Inventors: Elad LIBERMAN, Limassol (CY); Shlomi SHAAR, Sofia (BG); Liron ZIMBERG, Sofia (BG)

(21) Appl. No.: 19/159,665

(22) PCT Filed: Feb. 26, 2024
(86) PCT No.: PCT/IL2024/050216

§ 371 Date: Aug. 26, 2025

Related U.S. Application Data
(60) Provisional application No. 63/448,477, filed on Feb. 27, 2023.

(51) Int. Cl. G06Q 20/36; G06Q 20/40

(52) U.S. Cl. CPC G06Q 20/367; G06Q 20/401

(57) ABSTRACT

Disclosed herein are systems and methods for crypto transfer between a crypto wallet and a pool wallet. The system comprising a user interface for interacting with an application and a processing unit, which executes the application, which is configured to receive, from an individual beneficiary of the application, a transaction request, wherein the individual beneficiary is assigned a user ID. The application obtains/retrieves a transaction ID from a Blockchain, associates the transaction ID with the user ID and stores the associated transaction ID and user ID. Upon receiving into the pool wallet, a crypto transfer with its associated transaction ID from the Blockchain, the application matches the transaction ID of the crypto transfer with the stored transaction ID. The application labels the transferred crypto in the pool wallet with the associated user ID upon confirming a match between the stored transaction ID and the transaction ID of the crypto transfer.

### TECHNICAL FIELD

The present disclosure relates generally to systems and methods for crypto transferring between a crypto wallet and a pool wallet.

### BACKGROUND

Transferring crypto coins between a crypto wallet and a pool wallet is a basic operation for crypto users and is done many times every day all over the world. However, in order to identify a sender and to associate all of the sender's funds together, a crypto wallet is seamlessly opened for every sender in the pool wallet and moreover, in case the same sender transfers different crypto coins a dedicated crypto wallet is opened for every crypto coin. This operation of opening one or more dedicated crypto wallets for each sender is a cumbersome operation which takes time, computational resources and most of all is expensive as every opening of a crypto wallet costs a fee.

There is therefore a need in the art to provide systems and methods for crypto transferring between a crypto wallet and a pool wallet, in a usefully, easy and cost-effective manner.

### SUMMARY

Systems and methods for transferring crypto coins between a crypto wallet and a pool wallet are presented herein.

Advantageously, the system of the present disclosure allows to associate all the funds of an individual beneficiary in a pool wallet, to the individual beneficiary, without creating dedicated crypto wallets for each transaction/currency. This is achieved by assigning the transaction ID with the individual beneficiary's user ID.

As a further advantage, a total balance of an individual beneficiary can be presented, as opposed to as it is today, that only a plurality of separate sub-totals of an individual beneficiary's many crypto wallets within the pool wallet can be presented.

According to some embodiments, a system for transferring crypto coins between a crypto wallet and a pool wallet is presented herein. The system comprises a user interface (UI) for interacting with an application and a processing unit, wherein the processing unit executes the application code configured to:
receive, from an individual beneficiary of the application, a transaction request, wherein the individual beneficiary is assigned a user ID representing one or more user details and wherein the transaction request comprises a plurality of transaction details comprising: a crypto currency, an amount and a pool wallet address;
receiving a signing and approval of the transaction by a crypto wallet of the user;
receiving a validation of transaction by a Blockchain;
obtaining and/or retrieving a transaction ID from the Blockchain;
associating the transaction ID with the user ID;
storing the associated transaction ID and user ID;
receiving into the pool wallet a crypto transfer with its associated transaction ID from the Blockchain;
matching the transaction ID of the crypto transfer with the stored transaction ID;
labeling the transferred crypto in the pool wallet with the associated user ID upon confirming a match between the stored transaction ID and the transaction ID of the crypto transfer.

According to some embodiments, the processing unit executes a code further configured to indicate in the pool wallet a crypto balance of the individual beneficiary.

According to some embodiments, the processing unit executes a code further configured to transfer labelled crypto of the individual beneficiary from the pool wallet to a third party.

According to some embodiments, the third party is a second beneficiary in the pool wallet and wherein the transferred crypto is relabelled in the pool wallet with the second beneficiary's user ID.

According to some embodiments, the third party is not a beneficiary in the pool wallet and wherein the transferring comprises transferring the labelled crypto to an external wallet which is not associated with the pool wallet.

According to some embodiments, the crypto currency comprising: Bitcoin, Ethereum, Tether, BNB, USD coin, XRP, Binance USD, Cardano, Dogecoin, Polygon and Solana.

According to some embodiments, the transaction details further comprise transaction time.

According to some embodiments, upon receiving the transferred crypto in the pool wallet with transaction details, the application is configured to keep the transaction details of the transfer to the pool wallet in an Internal ledger of the application.

According to some embodiments, the UI comprises at least one of a group consisted of: a touch screen, a screen connected to a keyboard and/or a mouse, a joystick, VR interface and metaverse interface, and AR device or any combination thereof.

According to some embodiments, the processing unit executes the application code which is further configured to:
receive a request from the individual beneficiary to subscribe to the application;
assign a user ID to the individual beneficiary; and
connect one or more crypto wallet of the individual beneficiary to the application;
thereby, subscribing the individual beneficiary to the application.

According to some embodiments, the crypto wallet is a non-custodial wallet.

According to some embodiments, the pool wallet is a custodial wallet or a joint custodial wallet.

According to some embodiments, a method for transferring crypto coins between a crypto wallet and a pool wallet, is presented herein. The method comprises:
receiving, from an individual beneficiary of an application, a transaction request, wherein the individual beneficiary is assigned a user ID by the application representing one or more user details and wherein the transaction request comprises a plurality of transaction details comprising: a crypto currency, an amount and a pool wallet address;
receiving a signing and approval of the transaction by a crypto wallet of the individual beneficiary;
receiving a validation of transaction by a Blockchain;
obtaining and/or retrieving a transaction ID from the Blockchain;
associating the transaction ID with the user ID;
storing the associated transaction ID and user ID;
receiving into the pool wallet a crypto transfer with its associated transaction ID from the Blockchain;
matching the transaction ID of the crypto transfer with the stored transaction ID;
labelling the transferred crypto in the pool wallet with the associated user ID upon confirming a match between the stored transaction ID and the transaction ID of the crypto transfer.

According to some embodiments, the method further comprises indicate in the pool wallet a crypto balance of the individual beneficiary.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

### In the Figures:

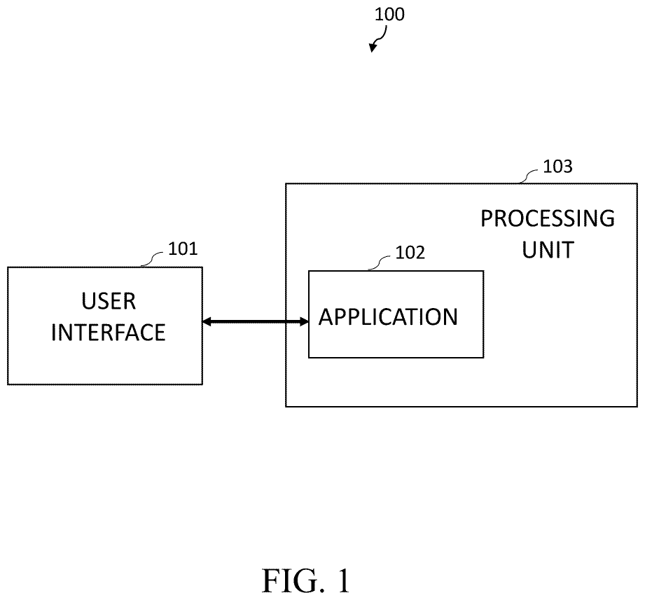

FIG. 1 schematically shows a block diagram of a system for transferring crypto coins between a crypto wallet and a pool wallet, according to some embodiments;

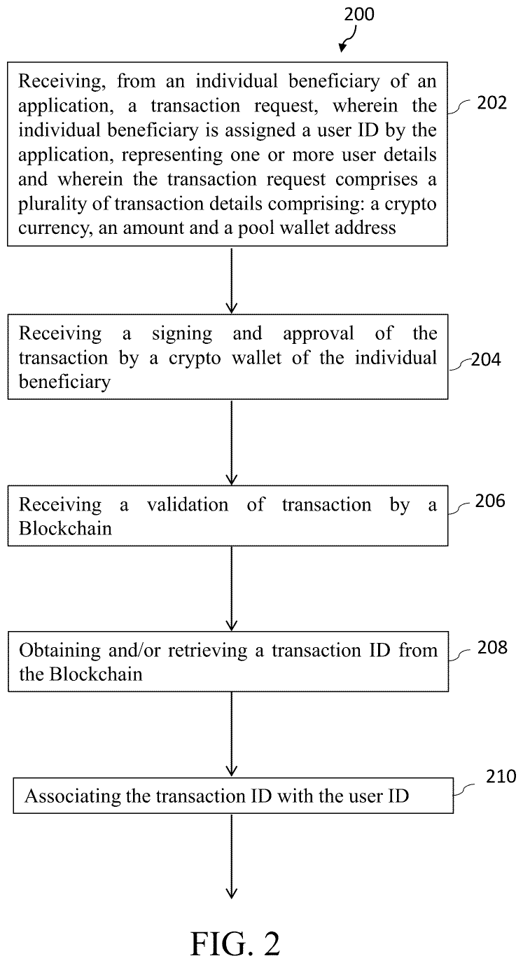

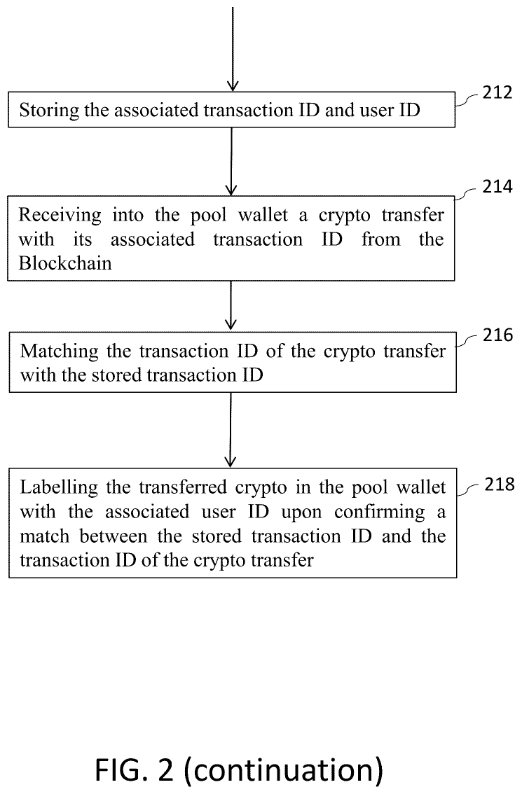

FIG. 2 schematically shows a flow-chart of a method transferring crypto coins between a crypto wallet and a pool wallet, according to some embodiments;

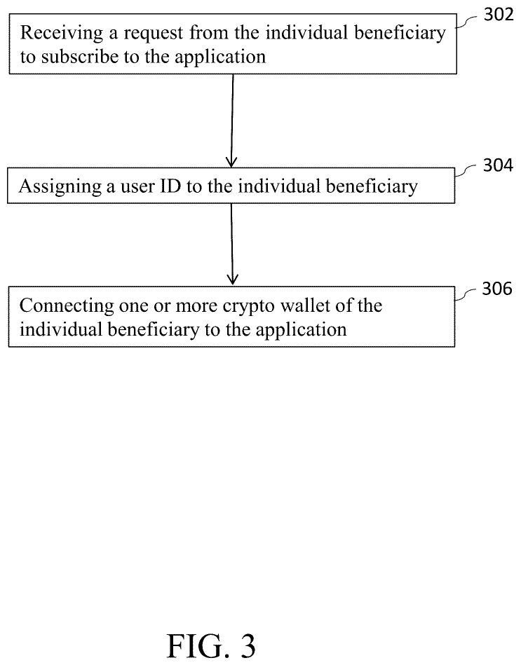

FIG. 3 schematically shows a flow char of a method for subscribing an individual beneficiary to application 102, according to some embodiments;

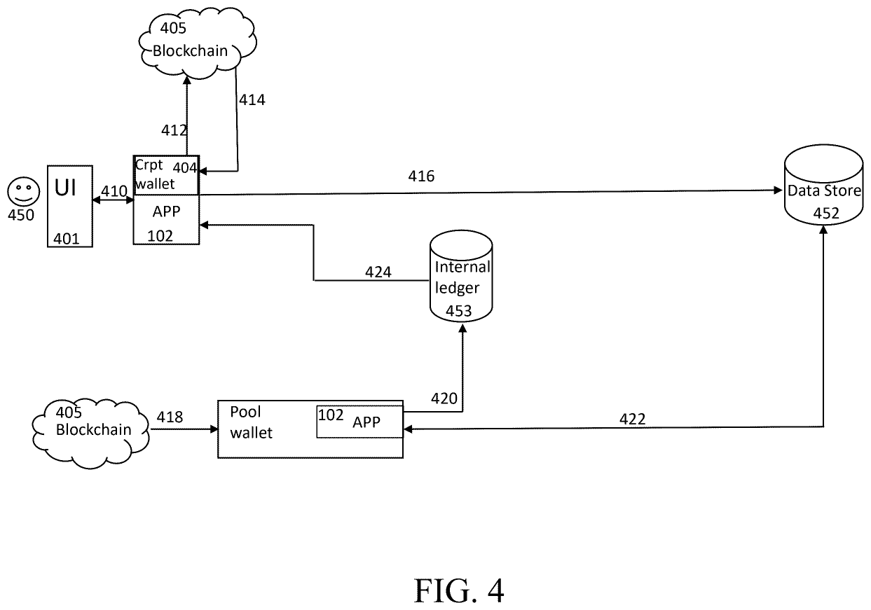

FIG. 4 schematically shows a diagram of an example of transferring crypto coins between a crypto wallet and a pool wallet, according to some embodiments; and

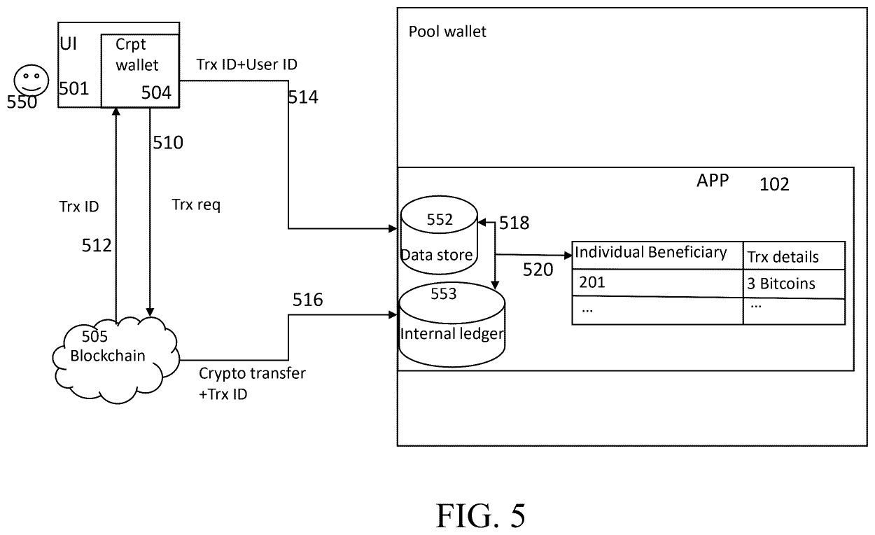

FIG. 5 schematically shows a diagram describing the labeling of a transferred crypto in a pool wallet, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g., the length of an element) to within a continuous range of values in the neighbourhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

According to some embodiments, a system for transferring crypto coins between a crypto wallet and a pool wallet is presented herein.

As used herein, according to some embodiments, the term “crypto wallet” may refer to any crypto wallet of any crypto currency, and the term “pool wallet” may refer to a joint wallet to which crypto coins may be deposited by a plurality of individual or corporate beneficiaries. As used herein, according to some embodiments, the term “individual beneficiary” may refer to a private person, a corporation, a limited liability company, a partnership or any other commercial entity. According to some embodiments, the individual beneficiary may be the sender and/or the receiver of crypto coins.

Reference is now made to FIG. 1, which schematically shows a block diagram of a system 100 for transferring crypto coins between a crypto wallet and a pool wallet, according to some embodiments.

System 100 includes a user interface (UI) 101 for interacting with an application 102 and a processing unit 103. According to some embodiments, UI 101 is used by an individual beneficiary of application 102 to interact with the application and to execute crypto transfers from the crypto wallet of the individual beneficiary to a pool wallet. According to some embodiments, UI 101 may be any UI for interacting with an application, such as but not limited to a smartphone, a tablet, a touch screen, a screen connected to a keyboard and/or a mouse, a joystick, virtual reality (VR) interface and metaverse interface, and augmented reality (AR) device or any combination thereof.

According to some embodiments, application 102 is configured to run on processing unit 103. According to some embodiments, processing unit 103 executes the code of application 102, which is configured to receive, from the individual beneficiary of application 102, a transaction request. Each individual beneficiary of the application is assigned a user ID representing one or more user details of the individual beneficiary. According to some embodiments, the user details may include a name, ID number, crypto wallet address and the like. According to some embodiments, the transaction request includes a plurality of transaction details including: a crypto currency, an amount and a pool wallet address. According to some embodiments, the transaction details may further include the transaction time, such as the date and hour of the transaction. According to some embodiments, application 102 executed by processing unit 103 is configured to receive a signing and approval of the transaction by the crypto wallet of the individual beneficiary and receives a validation of transaction by a Blockchain.

At this stage the Blockchain generates a transaction ID provided with the crypto transfer to sending crypto wallet and to the receiving crypto wallet. According to some embodiments, application 102 is configured to obtain and/or retrieve a transaction ID from the Blockchain, associate the transaction ID with the user ID and store the associated transaction ID and user ID. According to some embodiments, obtain and/or retrieve the transaction ID from the Blockchain may refer to listen and/or pool the transaction ID from the Blockchain.

According to some embodiments, after receiving into the pool wallet the crypto transfer with its associated transaction ID from the Blockchain, application 102 is configured to match the transaction ID of the crypto transfer with the stored transaction ID, and to label the transferred crypto in the pool wallet with the associated user ID upon confirming a match between the stored transaction ID and the transaction ID of the crypto transfer.

According to some embodiments, the application (102) is further configured to indicate in the pool wallet a crypto balance of the individual beneficiary, as all the funds of the individual beneficiary are associated with its user ID.

According to some embodiments, application 102 is further configured to transfer labelled crypto of the individual beneficiary from the pool wallet to a third party. According to some embodiments, the third party may be a second beneficiary in the pool wallet and in this case, the transferred crypto is relabelled in the pool wallet with the second beneficiary's user ID.

According to some embodiments, the third party may not a beneficiary in the pool wallet and in this case the transferring includes transferring the labelled crypto to an external wallet, which is not associated with the pool wallet.

According to some embodiments, upon receiving the transferred crypto in the pool wallet with transaction details, the application is configured to store the transaction details of the transfer to the pool wallet in an internal ledger of the application.

According to some embodiments, the processing unit executes an application code further configured to receive a request from the individual beneficiary to subscribe to the application. Assign a user ID to the individual beneficiary and connect one or more crypto wallet of the individual beneficiary to the application. Thereby, subscribing the individual beneficiary to the application.

According to some embodiments, the crypto wallet may be a non-custodial wallet, a hot wallet, a cold wallet or any crypto wallet.

According to some embodiments, the pool wallet may be a custodial wallet or a joint custodial wallet.

Reference is now made to FIG. 2 which schematically shows a flow chart of a method 200 for transferring crypto coins between a crypto wallet and a pool wallet, according to some embodiments. At step 202, a transaction request is received from an individual beneficiary of an application (such as application 102). The application is configured to run on a processing unit and includes a front-end part of the application, which is in charge to the interaction with a user through the user interface, and a back-end part of the application which is in charge of the operation of the application and cannot be accessed by the user. The individual beneficiary is subscribed to the application and is assigned a user ID representing one or more user details such as, a name, ID number, crypto wallet address and the like. According to some embodiments, the transaction request includes a plurality of transaction details including a crypto currency, an amount and a pool wallet address.

According to some embodiments, at step 204, the application is configured to receive a signing and approval of the transaction by a crypto wallet of the individual beneficiary, and at step 206, the application receives a validation of transaction by a Blockchain. According to some embodiments, at step 208, the application is configured to obtain and/or retrieve a transaction ID from the Blockchain. According to some embodiments, obtain and/or retrieve the transaction ID from the Blockchain may be by listening and/or pooling the transaction ID from the Blockchain. According to some embodiments, at step 210, the application is configured to associate the transaction ID with the user ID.

At step 212, according to some embodiments, the application is configured to store the associated transaction ID and user ID in a dedicated database of the application. According to some embodiments, at step 214, a crypto transfer with its associated transaction ID is received into the pool wallet from the Blockchain. According to some embodiments, at step 216, the application is configured to match the transaction ID of the crypto transfer with the stored transaction ID. The match is done by verifying that the transaction ID of the crypto transfer is the same as the stored transaction ID.

At step 218, according to some embodiments, the application is configured to label the transferred crypto in the pool wallet with the associated user ID upon confirming a match between the stored transaction ID and the transaction ID of the crypto transfer. According to some embodiments, the application is further configured to indicate in the pool wallet a crypto balance of the individual beneficiary.

According to some embodiments, the application is further configured to perform a one-time subscription to every individual beneficiary which uses the application. FIG. 3 schematically shows a flow chart of a method for subscribing an individual beneficiary to application 102, according to some embodiments.

At step 302, application 102 is configured to receive a request from the individual beneficiary to subscribe to application 102. At step 304, application 304 is configured to assign a user ID to the individual beneficiary, and at step 306 the application is configured to connect one or more crypto wallet of the individual beneficiary to the application, thereby, subscribing the individual beneficiary to application 102.

Reference is now made to FIG. 4, which schematically shows a diagram of an example of transferring crypto coins between a crypto wallet and a pool wallet, according to some embodiments. Individual beneficiary 450, uses a UI 401 to interact with the application 102 of the present disclosure. Individual beneficiary 450, is subscribed to application 102, and owns a crypto wallet 404 which is a non-custodial wallet, and which is connected to application 102. According to some embodiments, at 410 application 102 receives a transaction request from individual beneficiary 450. The transaction request includes transactions details of for example: transferring an amount of 3 bitcoins to an address of a pool wallet 451. At 412, the crypto wallet 404 of the individual beneficiary 450 sends the transaction request to Blockchain 405, which sings and approves the transaction request to the crypto wallet, and application 102 receives the singing and approval of the transaction from crypto wallet 404. At 414, the application (102) receives a validation of transaction by Blockchain 405, which provides a transaction ID. Application 102 obtains and/or retrieves the transaction ID from Blockchain 405 and associates the obtained and/or retrieved transaction ID with the user ID of individual beneficiary 450. At 416, application 102 stores the associated transaction ID and user ID in a dedicated data base 452 of the application. At 418 the crypto transfer with its associated transaction ID is received into the pool wallet 451 from the Blockchain 405. At 420, upon receiving the transferred crypto in the pool wallet with transaction details, application 102 stores the transaction details of the transfer to pool wallet 451 in an Internal ledger 453 of the application. According to some embodiments, at 422 application 102 matches the transaction ID of the crypto transfer with the stored transaction ID. Application 102 labels the transferred crypto in pool wallet 451 with the associated user ID upon confirming a match between the stored transaction ID and the transaction ID of the crypto transfer and at 424 the balance of individual beneficiary 450, in pool wallet 451 is updated and may be presented to the individual beneficiary upon request.

Reference is now made to FIG. 5 which schematically shows a diagram describing the labeling of a transferred crypto in a pool wallet, according to some embodiments. Individual beneficiary 550 uses a UI 501 to interact with the application 102 of the present disclosure. Individual beneficiary 550, is subscribed to application 102, and owns a crypto wallet 504 which is a non-custodial wallet, and which is connected to application 102. At 510 a transaction request is received to transfer 3 bitcoins from crypto wallet 504 to pool wallet 551. At 512 crypto wallet 504 of the individual beneficiary 550 sends the transaction request to Blockchain 505, which sings and approves the transaction request to the crypto wallet, and application 102 receives the singing and approval of the transaction from crypto wallet 504 (not shown). The application (102) receives a validation of transaction by Blockchain 505 (not shown), and at 514 Blockchain 505 provides a transaction ID. At 516, application 102 obtains and/or retrieves the transaction ID from Blockchain 505 and associates the obtained and/or retrieved transaction ID with the user ID of individual beneficiary 550. The associated transaction ID and user ID are kept/stored in a dedicated data base 552 of the application. The crypto transfer with its associated transaction ID is received into the pool wallet 551 from Blockchain 505. Upon receiving the transferred crypto in the pool wallet with transaction details, application 102 stores the transaction details of the transfer to pool wallet 551 in an Internal ledger 553 of the application (102). According to some embodiments, at 518 application 102 matches the transaction ID of the crypto transfer with the stored transaction ID. At 520, application 102 labels the transferred crypto in pool wallet 551 with the associated user ID upon confirming a match between the stored transaction ID and the transaction ID of the crypto transfer. The label is done such that a balance of individual beneficiary 550, in pool wallet 551 is updated and may be presented to the individual beneficiary upon request.

According to some embodiments, application 102 is further configured to transfer labelled crypto of the individual beneficiary from the pool wallet to a third party. According to some embodiments, the third party may be a second beneficiary in the pool wallet and in this case the transferred crypto is relabelled in the pool wallet with the second beneficiary's user ID.

According to some embodiments, the third party may not be a beneficiary in the pool wallet and in this case the transferring includes transferring the labelled crypto to an external wallet which is not associated with the pool wallet.

According to some embodiments, the individual beneficiary may be any beneficiary, including but not limited to, an individual person or a company.

According to some embodiments the crypto currency may be any crypto currency such as but not limited to:

AC Milan ($CHZ), AS Roma ($CHZ), Atlético de Madrid ($CHZ), FC Barcelona ($CHZ), Manchester City, FC ($CHZ), Decentral.games, Inter Milan ($CHZ), Juventus ($CHZ), Legia Warsaw ($CHZ), Napoli ($CHZ), Paris Saint-Germain ($CHZ), 1INCH Token, 1INCH Token (BSC), 1INCH Token (Ropsten), 1World, 2GT_token, 7EVEN Utility Token, Alpha5Token, ERC20, Aave interest bearing AAVE, Aave Token, AAVE AQ (Kovan), Binance-Peg Aave Token (BSC), Aave Token (Avalanche), Aave (Polygon), Aave BAT, The Abyss, Alchemy Pay, Acumen Governance Token (Solana), ADA (Cardano), Binance, Peg Cardano (BSC), ADA Test, Aave interest bearing DAI, Aave Interest bearing DAI (Old), Adamant AdHive, AdEx Network, Aave Interest bearing ETH, SingularityNET, SingularityNET Token, Adventure Gold, AGX Coin, Akropolis, Alchemix, Aladdin Token, Aladdin DAO Token, aleph.im v2, Alchemix ETH, Algory, Algorand, Algorand Test, USDC Test on Algorand, USDC on Algorand, USDT on Algorand, Artificial Liquid Intelligence Token, ALICE, ALICE (Ropsten), Aave Interest bearing LINK, Aave interest bearing LINK v2, Alkemi Network_DAO_Token, AlpaToken, AlpacaToken (BSC), AlphaToken, Altura, Alchemix USD, Ambrosus, AMLT, Amon, Amp, Ampleforth, Wrapped ANC Token, Ankr Network, Aragon, Aurora.io (Ethereum), ApeCoin, API3, APWine Token, APY Governance Token, Aave Arc Interest bearing ETH, Aave Arc Interest bearing AAVE, ARCA, Archer DAO Governance Token, ARPA Token, Burn, ASSEMBLE, AirSwap, Automata, ATD, Star Atlas (Solana), Cosmos Token (BSC), Cosmos Hub, Cosmos Hub Test, AtariToken, AtariToken(Ropsten), Aave interest bearing TUSD, Bounce Token, Audius, AURORA, Aave Interest bearing USDC, Aave Arc Interest bearing USDC, Aave interest bearing USDC (V2), AUX Coin, Avalanche (C-Chain), Avalanche (BSC), AVAX (Fuji Testnet), Aave Avalanche Market USDC, Aave interest bearing WBTC, Aave interest bearing WETH, Axie (Ronin), Axie Infinity Shard, Axie Infinity Shard (BSC), Axie Infinity Shard (Old), Axie Infinity Shard (Ronin), Axie Infinity Shard (Ropsten), B21 Token, B21 Dev Token (Ropsten), Bit2Me Token, Badger, BAGS, BAKE, Balancer, Balancer (Ropsten), ApeSwapFinance Banana (BSC), BandToken, Float Bank, Basic Attn., Basic Attention Token (Kovan), Badger Sett Badger, BlockBank, Binance Wrapped BTC, BCAP, Bitcoin Cash, Binance-Peg Bitcoin Cash Token (BSC), Bitcoin Cash Test, BlockchainPoland, BlackMason, BitcoinVend, Badger Sett Digg, Binance Wrapped DOT, BidiPass, Beanstalk, Bella, BELT Token (BSC), Bitpanda Ecosystem Token, Beta Token, Binance Beacon ETH (BSC), Bethereum, Bnk to the future, Biconomy Token, Bidao, Bistroo Token, BitDAO, Bibox Token, Blockkoin, Blockkoin (OLD), BANKEX, Blinc CAD, Blinc CHF, Blinc EUR, Blinc GBP, Blinc JPY, Blinc SGD, Blinc CAD Test, Blinc CHF Test, Blinc EUR Test, Blinc GBP Test, Blinc JPY Test, Blinc SGD Test, BELLCOIN, Blocto Token, Bluzelle, Bridge Mutual, Binance Coin (BSC), BNB (ERC20) Deprecated, Binance Coin Test (BSC), Bancor, BOB Token, BarnBridge Governance Token, Bondly Token, BONE SHIBASWAP, SpookyToken (Fantom), BoringDAO, Boson Token, BOSSC, Bounce Token, Starbots Token, BOXX Token, BitPro (RSK), Balancer: ETH/USDC 50/50 #7 , Balancer: LPT/ETH 50/50 #2 , Bread, BRZ Token (ETH), Bitcoin SV, Bitcoin SV Test, Bitcoin, Bitcoin (Fantom), Bitcoin Test, Binance-Peg BTCB Token (BSC), StandardBTCHashrateToken (BSC), BTRST token, BitTorrent (BSC), Burger Swap (BSC), Burp, Binance USD, Binance-Peg BUSD (BSC), Binance USD (BSC Test), Binance USD CR (Kovan), Baanx, Beyond Finance (ERC-20), bZx Protocol Token, BZZ, Crypto20, Compound Aave Token, ChangeBank, PancakeSwap Token (BSC), Capsule Coin, Crypto Cavemen (Solana), cBAT, Greenheart (BSC), Cobak Token, Crypto BRL, Compound Collateral, cDAI, cDAI (Ropsten), Blox, Celsius, Cell Doge (Celo), Celo, Celo (Alfajores Testnet), Celo (Baklava Testnet), CelerToken, Centrality Token, CERE Network, cEther, cETH Coin (Ropsten), Celo Euro, CFI, CoinShares Gold and Cryptoassets Index Lite, Chain Games, Tranchess (BSC), Chi Gastoken by linch, SolChicks, Chilli Token, Chroma, Chroma (BSC), SwissBorg Token, SwissBorg Test, CHATTY, Chiliz (ETH), Chiliz ($CHZ), Compound ChainLink Token, CoinLoan, Clover, Crowd Machine Compute Token, Compound Maker, Cindicator, Tether CNH (ERC20), Compound Token, Compound COMP AQ (Kovan), Binance-Peg Compound Coin (BSC), Compound (Ropsten)”, Convergence, cVault.finance, Contentos, COTI Token, Covalent, Cover Protocol, Clearpool, Covalent Query Token, CarryToken, Cream, cAugur, Crypto.com, CropperFinance (Solana), CRPA Mintable Token (Kovan), Crypterium, Crypterium (Old), CRUST, Cream USD Coin, Curve DAO Token, Curve DAO Token (Ropsten), cSAI, CustodigitToken, Solend SOL (Solana), Caspian, Compound Sushi Token, Gluwa Creditcoin Vesting Token, ClinTex, Centra, Cartesi Token, Compound TrueUSD, Cryptex, Somnium Space Cubes, CudosToken, CopperLong (Kovan), Compound Uniswap, CarbonUSD, Celo Dollar, Compound USD Coin, cUSD Coin (Ropsten), cTether, cUSDT (Ropsten), CopperShort (Kovan), Civic, CVX, cvxCRV, Cryowar Token (Solana), cWBTC, Crowns, Compound yearn finance, Cyclos, Compound 0x, DACSEE, DAD, DAFI Token, Dai, Dai BSC Token, Dai Stablecoin (Avalanche), Dai Stablecoin (Fantom), DAI NVAM (Kovan), (PoS) Dai Stablecoin (Polygon), Dai (Ropsten), DAI Uniswap (Ropsten), DAO Maker, Dash, Dash Test, Streamr Data, Streamr, DAEX Token, dego.finance, DENT, DEAPCOIN, Delta Exchange Token, DEXTools, dForce, DefiDollar DAO, Dotify Token, DFYN Token, DFYN Token (Polygon), Digitex, DigitexFutures, Digix Gold Token, dHedge DAO, DIAToken, Diem Test, Diem XUS Test, DigitalFinancialExch, Digg, DinoSwap (Polygon), Agrello, delta.theta, DMM: Governance, DNA, district0x, Dollar on Chain (RSK), Dock, DODO bird, DODO bird (BSC), Doge Coin, Binance-Peg Dogecoin (BSC), Doge Coin Test, Dopex Governance Token, Polkadot, Binance-Peg Polkadot (BSC), DefiPulse Index, Ally Direct Token, DRIFE, Dragon Coins, Dynamic Set Dollar, DigitalSecurity (Ropsten), DigitalUSD (Ropsten), Dusk Network, DeversiFi Token, Dvision, DXdao, Dexlab (Solana), dYdX, dYdX (Solana), Earth Token, EASY, FX-TO eAUD, FX-TO eCAD, FX-TO eCHF, Eden, Endor, FX-TO eEUR, Efinity Token, EfrontierUSD, FX-TO eGBP, FX-TO eJPY, aelf, Dogelon, EthermonToken, EtheremonToken, Emirex Token, FX-TO eMXN, EnderEdgeUSD, Enigma, Enjin Coin, Ethereum Name Service, EVNY Token, FX-TO eNZD, EOS, EOS Test, EpiK Protocol, Ellipsis (BSC), e-Pocket, Elrond, EthernityChain Token, Eristica, FX-TO eRUB, Empty Set Dollar, Ethereum Classic, Ethereum Classic Test, Ethereum, Binance-Peg Ethereum (BSC), Ethereum (FTM), Ether (Solana), Ethereum Test (Ropsten), Ethereum Test (Kovan), Ethereum Test (Goerli), Ethereum Test (Rinkeby), Ethereum Test (Sepolia), Arbitrum, Arbitrum (Testnet), Optimistic Ethereum, Optimistic Ethereum (Kovan), EthereumPoW, FX-TO eTRY, Elitium, Euro Coin, STASIS EURS Token, Tether EUR (ERC20), FX-TO eUSD, Evmos, Evn Token, Everex, E-RADIX, EASY V2 (BSC), FX-TO eZAR, FalconXUSD, Phantasia (Solana), FaucetToken (Ropsten), Fractal Protocol Token, Fei USD, Fetch, Fetch SH (Kovan), Binance-Peg Filecoin (BSC), StaFi, Polycat Finance (Polygon), FLEX Coin, FLEX Coin (SmartBCH), flexBTC, flexBTC (Ropsten), flexETH, flexETH (Ropsten), flexUSD, flexUSD (Kovan), flexUSD (SmartBCH), flexUSD (Ropsten), FLOKI, Flex Ungovernance Token, Fly Coin, Franklin, Fly Coin (Old), Fly Coin (SmartBCH), FOAM, Fodl, FolkvangUSD, The Force Token, handleFOREX, Ampleforth Governance, FOX, Frax, Frax (Avalanche), Frontier Token, Fusion, Futureswap Token, FARM_SUSHI, Fantom Token (ERC20), Fantom (BSC), Fantom, FTX Token, FTX Token (Solana), FTX Token (Ropsten), FunFair, Friends With Benefits Pro, Finxflo, Frax Share, Frax Share (Avalanche), FutureX Token, Gala, Game Credits, Gari (Solana), GATE, poundtoken, Globe Derivative Exchange, Genopets (Solana), GET Protocol, GuildFi Token, GGCOIN, Aavegotchi GHST Token, Glitch, Golem Network Token, Moonbeam, Gnosis, Golem, GooseFX, Governance OHM, GOVI, GrapefruitUSD, Growth, Graph Token, Graph Token (Ropsten), Global Social Chain, GSENetwork, Game.com, Gitcoin, Matchpool, Gemini USD, GMO JPY, GMO JPY (Kovan), GMO JPY (Ropsten), GazeCoin, Hedera Hashgraph, Hedera Hashgraph Test, Hubble Protocol Token (SPL), Huobi BTC, HBZ coin, HEDG, Hegic, Hero Arena, HEX, hi Dollar (BSC), Human Token, Holo, Hydro Protocol, Decision Token, Huobi Token, HT Chain, HT Chain Test, Huobi USD, Hxro, Ice Token, IDEX Token, IDKToken, Idoneus Token, Rupiah, Rupiah Token (Ropsten), Rupiah Token (BSC), Rupiah Token (BSC TEST), Inlock Token, Illuvium, Moneytoken, Immutable X, Insight Chain, Index, Injective Protocol, Insolar, Instadapp, InsurAce, INX token, Internxt, Charged Particles IONX, IOST, MIOTAC (BSC), IoTeX, IP Exchange, iTrust Governance Token, Banker Joe Link (Avalanche), Joe LP Token (Avalanche), JoeToken (Avalanche), Jupiter, Kard Coin, KatlaUSD, Kava, Karatgold Coin, KuCoin Token, King DAG, Keep Token, KelVpn Token, SelfKey, Knit Finance, Kin, KIN (Solana), Kine Governance Token, Kirobo, Kyber Network Crystal v2, KyberNetworkCrystal (Kovan), Kyber Network (Old), Kokoswap Token, Kokoswap Token, Keep3rV1, Kusama, Kusama (BSC), kUSDCoin, KinesisVelocityToken, LALA World, Larix (Solana), FC Lazio Fan Token, Cred, Leadcoin, Lido DAO Token, Lido DAO Token (Solana), ETHLend, Bitfinex LEO Token, LinkEye Token, Legacy Coin, LGO Token, LikeCoin, Only1 (Solana), iMe Lab, Linear Token, Chainlink, Binance-Peg ChainLink (BSC), Chainlink Token (Avalanche), ChainLink (FTM), ChainLink Token (Polygon), LionCoin, Litentry, Polkalokr, LML, LOCIcoin, LODE Token, LooksRare Token, Loom Token, Loom Token(Old), Launchpool token, Livepeer Token, LQTY, Loopring, Litecoin, Binance-Peg Litecoin (BSC), LTO Network Token, Lattice Token, Terra Classic Luna, Terra Luna 2.0, Terra Luna 2.0 Test, LUSD Stablecoin, LUKSO, Decentraland, MARS 4, Mask Network, Matic Token (Ethereum), Matic Token (BSC), Matic Gas Token (Polygon), MonkeyBucks (Solana), MCDEX Token, Crypto.com, Moss Carbon Credit, oeda Loyalty Points, MatrixETF DAO Finance (Solana), MANDALA EXCHANGE TOKEN, Memecoin, obileGo, Magic Internet Money, miMATIC (Polygon), MIMO Parallel Governance Token, Wrapped MIR Token, Mist, Mithril, Morpheus Labs, Maker, Binance-Peg Maker (BSC), MKR (Kovan), MILC Platform, Marinade (Solana), Mango, Mountain, Mountain VUSD, Moonriver, Maple Token, Marinade staked SOL (Solana), Meta, Meta Polygon, Metal, mStable USD, DMM: USDC, DMM: USDC (Ropsten), Maximine Coin, Mysterium, Nakamoto Debt Token, NAOSToken, Naxar (Solana), Nucleus Vision, NEAR Protocol, inance-Peg NEAR Protocol, NEAR Protocol Test, Ethfinex Nectar Token, Nest Arcade (Solana), “Nexo, NFT Protocol, APENFT, NFTX, NIAXToken, NibbioUSD, Unifty, Nahmii, NiiFiToken, NINJA, Autonio, NKN, Numeraire, NOIA Token, Nosana (Solana), Notional, noteUSD, Plus-Coin, Pundi X, Nsure Network Token, NuCypher, OCC, Ocean Token, Odyssey, Octo.fi, OriginToken, Olympus, OKB, Olyseum, MANTRA DAO, Augury Finance (Polygon), “OmiseGO, OMNI Coin, Harmony ONE (BSC), SoMee.Social, Binance-Peg Ontology Token (BSC), OPEN Chain, Opium Governance Token, OpulousToken, ORAO Network, Orbs, Orbit Chain, Orca, Orion Protocol, OST, O Token, Origin Dollar, Orchid, impactMarket (CELO), AID Network, PARETO Rewards, Blockpass, PAX Dollar, Paxos CR (Kovan), Paxos Gold, Paxos Gold (Ropsten), TenXPay, Orbit Bridge Polygon Binance Coin (Polygon) and Paribus.

Unless otherwise defined the various embodiment of the present invention may be provided to an end user in a plurality of formats, platforms, and may be outputted to at least one of a computer readable memory, a computer display device, a printout, a computer on a network, a tablet or a smartphone application or a user. Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software (or program code), selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “processor” “hardware processor” or “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. A system for transferring crypto coins between a crypto wallet and a pool wallet, the system comprising a user interface (UI) for interacting with an application and a processing unit, wherein the processing unit executes an application code which is configured to:
a. receive, from an individual beneficiary of the application, a transaction request, wherein the individual beneficiary is assigned a user ID representing one or more user details and wherein the transaction request comprises a plurality of transaction details comprising: a crypto currency, an amount and a pool wallet address;
b. receive a signing and approval of the transaction by a crypto wallet of the individual beneficiary;
c. receive a validation of transaction by a Blockchain;
d. obtain and/or retrieving a transaction ID from the Blockchain;
e. associate the transaction ID with the user ID;
f. store the associated transaction ID and user ID;
g. receive into the pool wallet a crypto transfer with its associated transaction ID from the Blockchain;
h. match the transaction ID of the crypto transfer with the stored transaction ID;
i. label the transferred crypto in the pool wallet with the associated user ID upon confirming a match between the stored transaction ID and the transaction ID of the crypto transfer.

2. The system of claim 1, wherein the processing unit executes a code further configured to indicate in the pool wallet a crypto balance of the individual beneficiary.

3. The system of claim 1, wherein the processing unit executes a code further configured to transfer labelled crypto of the individual beneficiary from the pool wallet to a third party.

4. The system of claim 3, wherein the third party is a second beneficiary in the pool wallet and wherein the transferred crypto is relabelled in the pool wallet with the second beneficiary's user ID.

5. The system of claim 3, wherein the third party is not a beneficiary in the pool wallet and wherein the transferring comprises transferring the labelled crypto to an external wallet which is not associated with the pool wallet.

6. The system of claim 1, wherein the crypto currency comprising: Bitcoin, Ethereum, Tether, BNB, USD coin, XRP, Binance USD, Cardano, Dogecoin, Polygon and Solana.

7. The system of claim 1, wherein the transaction details further comprise transaction time.

8. The system of claim 1, wherein upon receiving the transferred crypto in the pool wallet with transaction details, the application is configured to keep the transaction details of the transfer to the pool wallet in an Internal ledger of the application.

9. The system of claim 1, wherein the UI comprises at least one of a group consisted of:
a touch screen, a screen connected to a keyboard and/or a mouse, a joystick, VR interface and metaverse interface, and AR device or any combination thereof.

10. The system of claim 1, wherein the processing unit executes the application code which is further configured to:
receive a request from the individual beneficiary to subscribe to the application;
assign a user ID to the individual beneficiary; and
connect one or more crypto wallet of the individual beneficiary to the application;
thereby, subscribing the individual beneficiary to the application.

11. The system of claim 1, wherein the crypto wallet is a non-custodial wallet.

12. The system of claim 1, wherein the pool wallet is a custodial wallet or a joint custodial wallet.

13. A method for transferring crypto coins between a crypto wallet and a pool wallet, the method comprising:
receiving, from an individual beneficiary of an application, a transaction request, wherein the individual beneficiary is assigned a user ID by the application representing one or more user details and wherein the transaction request comprises a plurality of transaction details comprising: a crypto currency, an amount and a pool wallet address;
receiving a signing and approval of the transaction by a crypto wallet of the individual beneficiary;
receiving a validation of transaction by a Blockchain;
obtaining and/or retrieving a transaction ID from the Blockchain;
associating the transaction ID with the user ID;
storing the associated transaction ID and user ID;
receiving into the pool wallet a crypto transfer with its associated transaction ID from the Blockchain;
matching the transaction ID of the crypto transfer with the stored transaction ID;
labelling the transferred crypto in the pool wallet with the associated user ID upon confirming a match between the stored transaction ID and the transaction ID of the crypto transfer.

14. The method of claim 13, further comprising indicate in the pool wallet a crypto balance of the individual beneficiary.
